(19) United States
(12) Patent Application Publication
(10) Pub. No.: US 2006/0106636 A1
(43) Pub. Date: May 18, 2006

(54) Internet-based job placement system for creating proposals for screened and pre-qualified participants

(76) Inventor: Hillel Segal, Boulder, CO (US)

Correspondence Address: PATTON BOGGS, 1660 LINCOLN ST, SUITE 2050, DENVER, CO, 80264, US

(21) Appl. No.: 11/320,391

(22) Filed: Dec. 28, 2005

Related U.S. Application Data
(63) Continuation-in-part of application No. 11/102,925, filed on Apr. 8, 2005.
(60) Provisional application No. 60/560,491, filed on Apr. 8, 2004.

(51) Int. Cl. G06Q 99/00

(52) U.S. Cl. 705/1

(57) ABSTRACT

The present automated job placement system uses a multi-step process, with advanced screening and pre-qualification of candidates and positions, to match qualified prospective employees with job openings. The system supports two types of participant match processes that involve participants acting simultaneously. One match process involves prospective employees offering proposals for available jobs, and the second match process involves prospective employers offering proposals to prospective employees. Both types of participant match processes use an Internet website for proposal exchanges. In addition, this automated job placement system provides built-in deadlines for each step, with an easy-to-use proposal tracking and active proposal reminder mechanism. This system also enables the listing party to create minimum levels necessary for the party filling out the checklists to be deemed a qualified applicant and also enables the listing party to adjust these limits up or down to narrow or expand the number of qualified applicants.

### CROSS-REFERENCE TO RELATED APPLICATIONS

This application is a Continuation-In-Part of U.S. patent application Ser. No. 11/102,295 filed on Apr. 8, 2005 and titled “Internet-Based Job Placement System For Managing Proposals For Screened And Pre-Qualified Participants”, which is related to U.S. Provisional Application Ser. No. 60/560,491 filed on Apr. 8, 2004 and claims priority to that application.

### FIELD OF THE INVENTION

The present Internet-Based Job Placement System relates to a system that enables the use of a multi-step process to manage the exchange of proposals between participants using advanced screening and pre-qualification of candidates and employers. This Continuation-In-Part expands upon the advanced screening and pre-qualification procedures.

### BACKGROUND OF THE INVENTION

As mentioned in our initial application, it is a problem in the field of Internet-based job search systems that existing systems use a single step process to simply match employee candidate descriptions with existing job position descriptions. This match process is executed without regard to pre-approval of the candidates (whether the candidates are prospective employees or prospective employers) and does not rely on screening criteria to distinguish between qualified candidates and unqualified candidates. Therefore, the results of the match process are often misleading and unusable because unqualified or unsuitable prospective candidates are compared to qualified or suitable prospective candidates. In addition, the existing Internet-based job search systems fail to provide the participants with access to a repository of screening questions and criteria with the ability to modify such questions and criteria to suit the particular situation.

### BRIEF SUMMARY OF THE INVENTION

The above-described problems are solved and a technical advance achieved by the present automated job placement system which is implemented using an Internet website and which uses a multi-step, real-time driven process, including advanced screening and pre-qualification of employee candidates and/or employers, to match qualified prospective employees with job openings. A unique aspect of the system, as mentioned in the above-noted U.S. patent application titled “Internet-Based Job Placement System For Managing Proposals For Screened And Pre-Qualified Participants,” is the advanced screening and pre-qualification process. This Continuation-In-Part addresses the ability of the party that is defining the screening and pre-qualification criteria to customize and make changes to the criteria to fit the specific situation.

The automated job placement system supports two types of participant match processes that involve prospective employers and prospective employees, each acting simultaneously. Both types of participant match processes use similar procedures, with all proposal exchanges taking place via the automated job placement system Internet website. In a first type of participant match process, prospective employers list job openings and skills-screened, pre-qualified prospective employees transmit employment proposals for selected listings to the automated job placement system Internet website; while in the second type of participant match process (the reverse participant match processes), the prospective employees list their availability and criteria-screened, pre-qualified prospective employers transmit proposals for employment to the automated job placement system website for selection by the prospective employees. A unique feature of this automated job placement system is the inclusion of an extensive pre-qualification procedure whereby employees/employers must first meet pre-defined screening criteria in order to be able to participate in the participant match process. The unique feature of this Continuation-In-Part is the ability of the listing party (who is defining the screening and pre-qualification criteria) to modify, add, or delete the specific questions that comprise the criteria for the specific situation, and for the listing party to set the minimum levels necessary for the party filling out the checklists to be deemed a qualified applicant.

The automatic real-time nature of this on-line process is what makes it easy to use. In addition, the prospective employer can maintain their job postings in secrecy until a pool of pre-qualified prospective employees has been located. The match process then links pre-qualified employee candidates with job postings to ensure both the accuracy of the match and the appropriateness of the selection. This process is thereby also beneficial to employment agencies where prospective employees can be screened by the employment agency and then matched to a pool of pre-qualified job postings, where the matches identify one or more job postings to prospective employees. In this case, the prospective employee need not search through job postings or request a specific job, but can be matched to a job posting that they may not even be aware of, but for which they are eminently qualified.

This automated job placement system provides the parties with the ability to exchange proposals within specific built-in deadlines, after each party has been pre-approved and screened ahead of time by the other party, with an easy-to-use proposal tracking mechanism that maintains a listing of the entire set of exchanges between the participants. The use of proposals and counter-proposals enables the participants to define a mutually agreeable employment relationship. In addition, reminders are provided to the prospective employee and prospective employer to indicate the expiration time of a presently active proposal or counter-proposal, thereby providing continuing feedback to the participants regarding the present state of the negotiations.

### BRIEF DESCRIPTION OF THE DRAWINGS

FIGS. 1A-1D illustrate, in block diagram form, the present automated job placement system and a typical environment in which it operates;

FIGS. 2A and 2B illustrate, in flow diagram form, the operation of the present automated job placement system to match pre-qualified prospective employees with a job posting;

FIG. 3 illustrates, in flow diagram form, the operation of the new editing module that is used by the lister in preparation of skills or criteria checklists, which is the basis of this Continuation-In-Part; and

FIG. 4 illustrates, in flow diagram form, the operation of the present automated job placement system to enable a lister to adjust the limits set in the skills checklist to modify the number of matches that are presented.

### DETAILED DESCRIPTION OF THE INVENTION

The present automated job placement system is typically implemented in an Internet environment, where the automated job placement system resides on one or more servers which are connected to the Internet and provide a user interface via a Website. The participants use their terminal equipment to connect to the Website to enter data therein and to retrieve information from the Website, as described below. Since there are numerous possible implementations of the automated job placement system and the communications environment in which it operates, one embodiment has been selected to illustrate the concept of the system and the functionality provided by this system.

The functionality of the present automated job placement system extends to applications beyond the matching of prospective employees with job postings, but for the purpose of simplicity of description to illustrate the underlying architecture of the automated job placement system, the case of matching of prospective employees with job postings is used to illustrate the invention. It is expected that variations of the system architecture, the system implementation, and application of the described functions to other applications are well within the skill of those knowledgeable in this art, and would fall within the scope of the appended claims.

Participant Terminal Equipment and Communications Environment

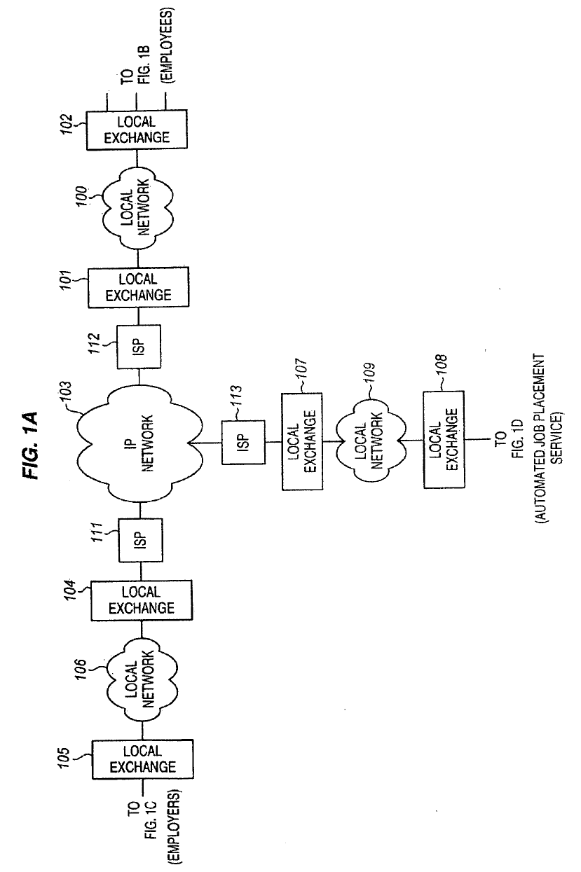

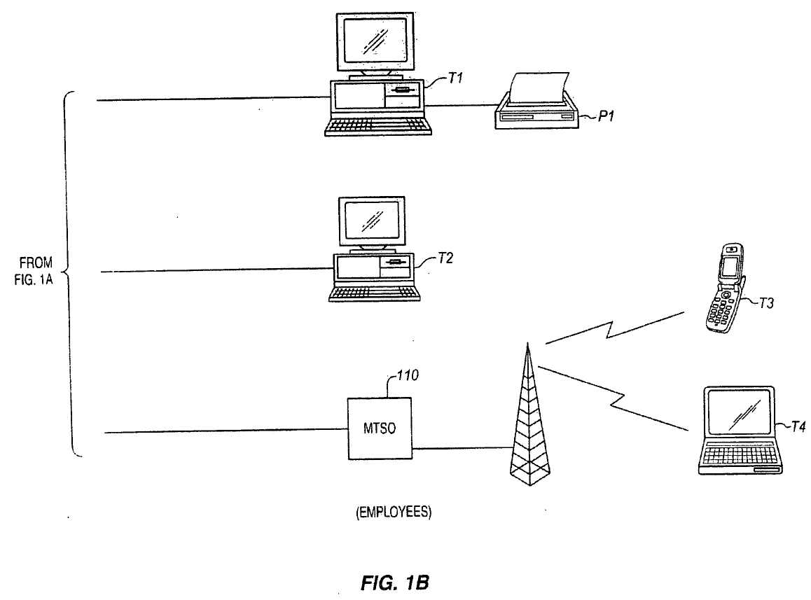

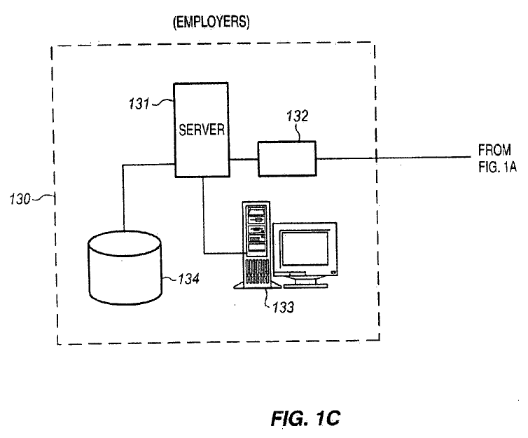

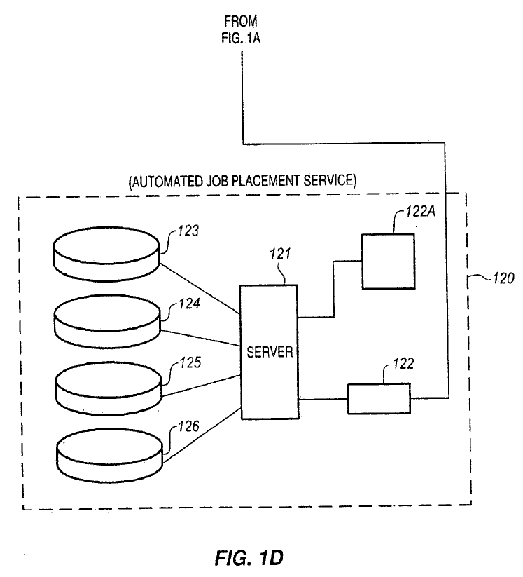

FIGS. 1A-1D illustrate, in block diagram form, the present automated job placement system 120 and a typical environment in which it operates. The participants are typically equipped with a personal computer T1 and printer P1, or computing device T2, or cellular communication device T3, or wireless computer device T4, or other data interface device, collectively termed “terminal equipment” herein. The data communication connection between the participant's terminal equipment T1 and the automated job placement system 120 can be via a data communication medium (such as the Internet), termed IP Network 103 herein, using the well-known personal computer modem and browser technology available at the participant's terminal equipment T1. The participant's terminal equipment is generally served by the Public Switched Telephone Network (PSTN), which consists of a plurality of Local Exchange Systems 101-102, 104-105, 107-108 interconnected via Inter-Exchange Carrier Networks 100, 106, 109, respectively. The physical connection that supports this data communication connection is typically effected from participant's terminal equipment T1 through the Local Exchange System 102 of the Public Switched Telephone Network (PSTN) to the data communication medium, IP Network 103, via an Internet Service Provider 112, which is also connected thereto. The IP Network 103 is also connected to a Local Exchange System 107 via Internet Service Provider 113, which in turn is connected via Inter-Exchange Carrier Network 109 and Local Exchange System 108 to gateway 122 of the automated job placement system 120. Alternatively, the participant's terminal equipment, in the case of cellular communication device T3, or wireless computer device T4, are connected via the Mobile Telecommunications Switching Office (MTSO) 110 to the Public Switched Telephone Network (PSTN).

The automated job placement system 120 consists of one or more software modules 122A, which reside on one or more servers 121, which are connected to the Internet and provide a user interface via a Website. The operation of these software modules 122A is described below to illustrate several of the functions that are provided by the automated job placement system 120. The automated job placement system 120 supports two types of participant match processes that involve, for example, prospective employers and prospective employees. Both types of participant match processes use similar procedures, with all exchanges of proposals taking place on an Internet website. In the first type of participant match processes, the prospective employers list job openings and prospective employees place employment proposals for selected ones of the listings on the Internet website; while in the second type of participant match processes (the reverse participant match processes), the prospective employees list their availability and prospective employers place employment proposals, directed to selected employees, on the Internet website. A unique feature of the automated job placement system is the inclusion of a pre-qualification procedure whereby employees/employers must meet pre approval criteria to participate in the match process. The automated job placement system 120 maintains a number of databases to store the information provided by the prospective employers and prospective employees. For example, job description database 123 stores data provided by the prospective employer (typically including employee qualification forms) for use in matching prospective employees with job postings. In addition, employee database 124 stores completed employee qualification forms, while employer database 125 stores subscriber data that identifies prospective employers who are subscribers to the service provided by the automated job placement system 120. In addition, match database 126 stores data that identify matches between prospective employers and prospective employees and the proposals that are exchanged between the parties pursuant to the match. The automated job placement system 120 typically also stores and makes available to subscribers various qualification forms and/or typical entries for use in the job posting skills checklists, as described below. It is obvious that the data in the various databases can be linked in well-known fashion and/or that the databases can be integrated into a lesser number of databases.

The pre-qualification procedure of the present job placement system entails limiting which prospective employees are able to place proposals on the automated job placement system 120 to only those prospective employees who have been approved by the prospective employer. Without the pre-qualification step, unqualified prospective employees end up placing proposals in competition with qualified prospective employees and the end result is not usable by the prospective employer. In order for a prospective employee to become pre-qualified, the person fills out a special on-line form that is directed to the prospective employer, employment agency, or other authorized organization by the automated job placement system 120. This step allows the pre-filed profile of the prospective employee to be reviewed and qualified. The qualification process may include any of a number of data gathering or confirmation steps, including but not limited to: verification of employment history, ensuring completeness of data entries, requesting additional data from the prospective employee, and the like. If the prospective employee is found to be acceptable for the process, the prospective employer marks the record “Accepted” and the prospective employee is then notified and allowed to enter offers.

Matching Pre-Qualified Prospective Employees with a Job Posting

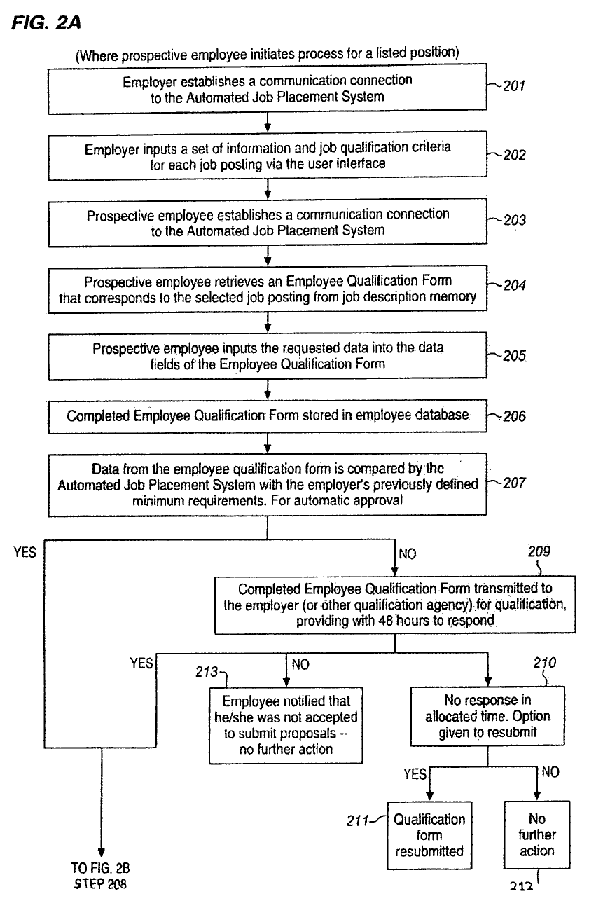

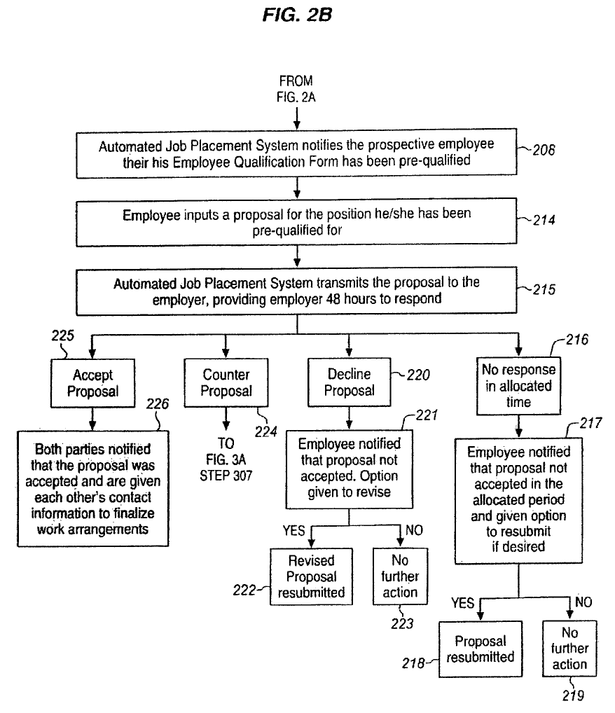

FIGS. 2A and 2B illustrate, in flow diagram form, the operation of the present automated job placement system 120 to match pre-qualified prospective employees with a job posting. In this case, prospective employers list job openings and prospective employees initiate contact with the prospective employer(s) by placing proposals in the automated job placement system 120 for selected ones of the listings. What makes the entire on-line employment transaction feasible is the pre-qualification process, because this limits which prospective employees are able to place proposals to only those who have been approved by the prospective employer. Without the pre-qualification step, unqualified prospective employees end up being compared against qualified prospective employees and the end result is not usable by the prospective employer.

In step 201 in FIG. 2A, the prospective employer establishes a communication connection from their terminal equipment 133 in the employer's computer system 130 through server 131 and gateway 132 via a plurality of Local Exchange Systems 104, 105 interconnected via an Inter-Exchange Carrier Network 106 and Internet Service Provider 111 through IP Network 103 to the automated job placement system 120, as described above. The prospective employer then inputs at step 202 a set of information and job qualification criteria for each job posting via the user interface hosted by server 121 (as described below). The user interface includes the appropriate login, security, and display management processes as is known in the art. This data provided by the prospective employer (typically including an employee qualification form) is stored in job description database 123 for use in matching prospective employees with the job posting.

Prospective employees can also establish a communication connection at step 203 from their terminal devices, such as terminal device T2, to the automated job placement system 120, as described above, to review the job postings that reside on the automated job placement system 120 in job description database 123. A prospective employee who wishes to enter their job qualification information into automated job placement system 120 retrieves an employee qualification form that lists the set of skills and criteria that correspond to the selected job posting from job description database 123 at step 204 and inputs the requested data into the data fields of the employee qualification form at step 205. At step 206, the completed employee qualification form is stored in employee database 124 and also transmitted to the employer (or other qualification agency) for pre-qualification.

Once the employee qualification form has been stored in employee database 124, the present automated job placement system 120 links the data from the employee qualification form in employee database 124 with the job posting stored in job description database 123, at step 207. As part of this process, the automated job placement system 120 automatically evaluates the correspondence between the criteria that identify the previously defined minimum requirements associated with this job posting and qualifications of prospective employees for this job posting as stored in employee database 124. The comparison of the two sets of data (minimum requirements of the job posting, qualifications of prospective employees) uses well-known algorithms which function to compare the contents of two data sets, using appropriate rules and procedures to insure a meaningful determination of a match or the failure to match There are numerous such processes known in the art, and a description of a specific process for use in the present automated job placement system 120 is beyond the scope of this description; therefore, it is not described herein.

The automated job placement system 120, upon determination of a sufficient correspondence between the two sets of data, then automatically notifies the prospective employee at step 208 that their employee qualification form has been pre-qualified, thereby providing timely feedback to the prospective employee relating to their submission of an employee qualification form.

If, at step 207, the automated job placement system 120 determines that there is an insufficient correspondence between the two sets of data, then processing advances to step 209, where the automated job placement system 120 transmits the completed employee qualification form to the prospective employer (or other qualification agency) for processing to determine whether the employer deems there to be a sufficient match to pursue further consideration of this prospective employee.

The employee qualification form can include a “skills checklist” to the employee profiles. Each job listed by the automated job placement system 120 has a skills checklist that lists specific tasks unique to that job, and the form typically asks the prospective employee to rate their own experience with that task For example, one of the 50 questions for a secretarial job maybe the person's proficiency using the Microsoft Word program. The prospective employee would be asked to check one of the following levels—no experience with this program, under six months daily use of this program, six months to two years daily use of this program, more than two years of daily use of this program In addition, the skills checklist can address numerous other criteria that are relevant to the job posting. These criteria can include, but are not limited to: educational background, professional experience, professional licenses, job experience, ability to travel, foreign language skills, etc. The skills checklist and employee qualification form thereby allows the prospective employer to review a profiled profile of the prospective employee.

The data input by the prospective employee can be further authenticated by transmitting it to an authentication agency or by having the prospective employer verify the accuracy of the credentials presented by the prospective employee. The authentication of the prospective employee data can entail verification of employment history, verification of education, executing a credit check, performing a criminal background check etc. Since these steps are laborious, it is likely that an employment screening agency can be employed to pre-qualify prospective employees who have input data into the automated job placement system 120.

The employer is provided with a time limit in which to respond to this submission (such as 48 hours) to thereby maintain a deadline driven process to ensure timely responses to the prospective employee's submission of an employee qualification form. If the employer fails to respond within the designated time, at step 210 the prospective employee is notified of the employer's inaction and is provided with the option of resubmitting the completed employee qualification form into the job applicant selection process for the posted job. If no action is taken by the prospective employee, then at step 212 the processing of this employee qualification form for this job posting is terminated. If the prospective employee requests resubmission at step 211, then the completed or amended employee qualification form is resubmitted to the employer at step 209 and the time limit for the employer's response is reset to ensure timely action by the employer on the submitted employee qualification form.

In the processing of the completed employee qualification form at step 209, if the employer rejects the form, then at step 213 the prospective employee is automatically notified by the automated job placement system 120 that they were not accepted and they are ineligible to submit proposals to the employer for this job posting. The rejection notice may include specific indications of the lack of qualifications of the prospective employee for this job posting, so the prospective employee understands the ground for the rejection of their employee qualification form. This timely feedback enables the prospective employee to search for other job postings that may be appropriate for their skill set. It is also envisioned that the automated job placement system 120 may immediately reject submitted employee qualification forms if they are so deficient that they should not be submitted to the employer, thereby rendering this process less time consuming for the employer. In that case, the automated job placement system 120 functions as the agent of the employer at steps 207, 209.

In the processing of the completed employee qualification form at step 209, if the employer accepts the form, then processing advances to step 208. Once the prospective employee's employee qualification form is accepted, either automatically by the automated job placement system 120 at step 207 or by the employer at step 209, processing advances to step 214 where the employee inputs a proposal to the automated job placement system 120 for the position for which they have been pre-qualified. At step 215, the automated job placement system 120 transmits the received employee proposal to the employer, and the employer is provided with a time limit in which to respond to this submission (such as 48 hours) to ensure a timely response to the submitted proposal If the employer fails to respond within the designated time, as determined at step 216, the employee is notified that their proposal was not acted upon within the allotted time, and the prospective employee is provided with the option of resubmitting their proposal in original or amended form to the employer for this job posting at step 217. If no action is taken by the prospective employee, then at step 219 the processing of this employee proposal for this job posting is terminated. If the employee resubmits their proposal or an amended proposal to the automated job placement system 120 at step 218, then this new proposal is transmitted to the employer at step 215 as described above and the time limit for responding to this submission is reset.

In the processing of the employee proposal at step 215, if the employer declines the proposal as determined at step 220, then at step 221 the prospective employee is automatically notified by the automated job placement system 120 that their proposal was not accepted and they are eligible to submit further proposals to the employer for this job posting. The rejection notice may include specific indications for the rejection of the proposal, so the prospective employee understands the ground for the rejection of their proposal. If no action is taken by the prospective employee, then at step 223 the processing of this employee proposal for this job posting is terminated. If the employee inputs at step 222 an amended proposal to the automated job placement system 120 for the position for which they have been pre-qualified, then the automated job placement system 120 submits the newly submitted prospective employee's proposal to the employer at step 215 and the time limit for the employer's response is reset to ensure timely action by the employer on the submitted proposal

In the processing of the employee proposal step 215, if the employer submits a counter-proposal to the prospective employee at step 224 through the automated job placement system 120, then processing advances to step 307, as described below.

In the processing of the employee proposal step 215, if the employer accepts the prospective employee's proposal at step 225, then processing advances to step 226, where the automated job placement system 120 automatically notifies both parties that the proposal was accepted by the employer and provides contact information to both parties (prospective employee and employer) to enable the parties to finalize the arrangements for the mutually agreed-upon employment relationship.

Skills Checklist Creation

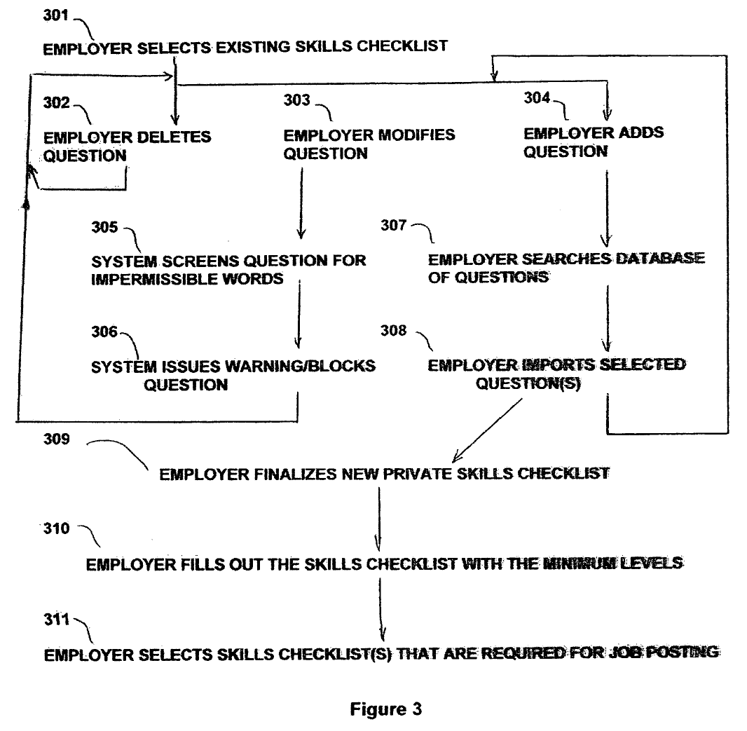

FIG. 3 illustrates, in flow diagram form, the operation of the present automated job placement system to enable participants to create skills checklists from existing checklists or new checklists. FIG. 3 is an expansion of step 202 described above, and is the essence of this Continuation-In-Part.

When the employer is connected to the automated job placement system 120 to input a job posting, that is when the skills checklist is defined for the particular job. The employer is able to choose from generic skills checklists that are provided by the automated job placement system 120 for each type of job or from unique skills checklists that they have drafted in the past and stored in employer database 125 under their unique password-protected identifier. Similarly, the employer is able to choose from generic skills checklist questions that are provided by the automated job placement system 120 for each type of job or from unique skills checklist questions that they have drafted in the past and stored in employer database 125 under their unique password-protected identifier. The employer is able to pick an existing skills checklist that is stored in automated job placement system 120 from either of the above categories and then edit the selected skills checklist to prepare a new unique skills checklist for the present job posting at step 301. The employer is able to give a unique name for this new skills checklist and store the draft skills checklist in employer database 125 for future use or post the completed skills checklist in the job description database 123.

Step 301 is an expansion of Step 202, where the employer selects an existing skills checklist. Once this is done, the employer can then delete a question (step 302), modify any line item on the existing skills checklist (step 303), or add new questions (step 304). If the skills checklist is modified at step 303, the system would have the ability to screen questions at step 305 for impermissible words and issue warnings to the skills checklist preparer about them, or ban the use of certain words completely at step 306. There can be categories of questions stored in memory in automated job placement system 120 (such as: educational background, professional experience, professional licenses, job experience, ability to travel, foreign language skills, etc.) such that the employer can search the database of questions in a selected category at step 307 and determine which of these previously stored questions are appropriate for the present job posting. Selected questions or groups of questions can be imported at step 308 into the present skills checklist to customize this skills checklist for the present job posting. In this manner, the employer does not have to create every question from scratch, but can rely on previously used questions from their past skills checklists or standard questions presented by the automated job placement system 120.

The result is a new private skills checklist finalized at step 309 that may only be used by the particular employer, unless permission is provided to the automated job placement system 120 to authorize access to the public. The next step 310 is for the employer to fill out the skills checklist with the minimum levels required for the prospective employee to be considered a qualified applicant. For essay or informational questions, the employer can define an empty field (a field left blank) to be acceptable or unacceptable. Some fields might have various data validity checks that the user defines for approval—for example, a particular kind of license number might always start with a letter and be followed by 8 numbers. The final step of 311 is for the employer to pick which skills checklists are required (it maybe more than one) for the particular job being listed.

Note that all of the above functionality is for the employer to establish skills checklists for the prospective employees to fill out. However, all the same functionality goes the other way as well—the job seeker is able to establish characteristic checklists for the prospective employer to fill Out in order for the company to be deemed a qualified employer to make an offer to the job seeker. In other words, all the systems and procedures go both ways.

On the employer's or prospective employee's website summary pages is listed all the lists that they've filled out. That way, if another application requires the same checklist, it would not need to be filled out again. (This is similar to the storing of resumé or company information in the database.) Job titles for the skill checklists can be presented in alphabetical order or can be found in the database maintained in automated job placement system 120 by looking for a keyword or character string.

Adjusting Skill Checklist Levels

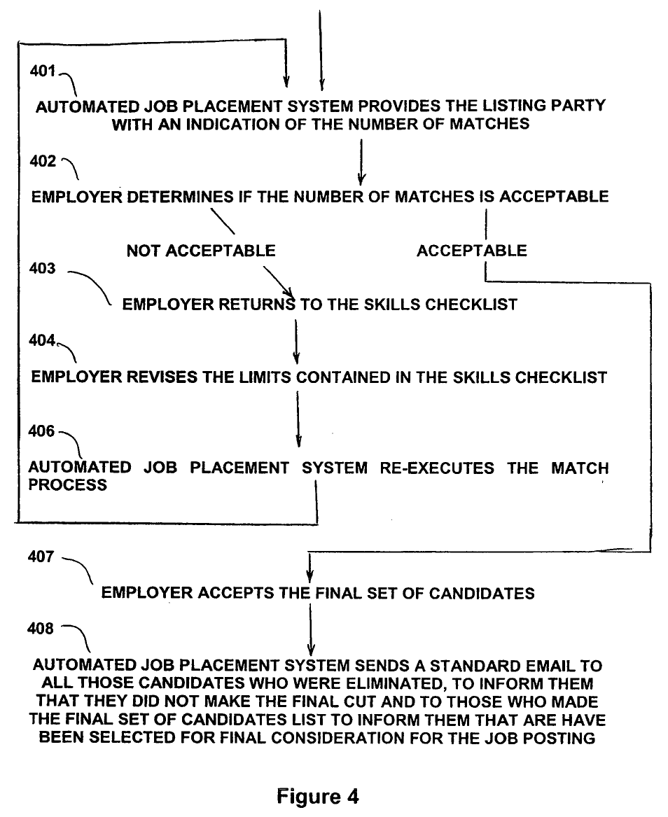

FIG. 4 illustrates, in flow diagram form, the operation of the present automated job placement system to enable a lister to adjust the limits set in the skills checklist to modify the number of matches that are presented. At step 207 in FIG. 2, where the automated job placement system 120 determines matches, it can also provide at step 401 the listing party with an indication of the number of matches that are determined and then proceed to step 208 in FIG. 2 where the candidates are notified that they have been pre-qualified for this job posting. If the number of matches is not acceptable (as determined by the employer) at step 402, then the employer can return to the skills checklist at step 403 and revise the limits set therein at step 404 to enable the automated job placement system 120 to re-execute the match process at step 406 to reduce the number of matches and therefore locate only the most appropriate qualified candidates.

For example, if 1,000 people apply for a particular job, and 500 are deemed by the automated job placement system 120 to be qualified applicants, based on the existing skills checklist, this indication is provided to the employer. The employer now realizes that they “set the bar too low” and too many people qualified. The automated job placement system 120 gives the employers the ability to change any of their previous requirements on the checklist. For example, let's say that they increase the amount of experience necessary for task A from 1 year to 2 years, and they see that that further narrows the field down to 250. The employer can then increase the amount of experience necessary for task B from 1 to 2 years, and they see that that further narrows the field down to 50. This limit editing process continues seriatim, until the employer gets down to the top 10 (or whatever number is selected) candidates who they decide to invite in for interviews. Once this editing process is concluded and the employer accepts the final set of candidates at step 407, the automated job placement system 120, in the case where the number of matches is excessive, sends a standard email to all those candidates who were eliminated at step 408, informing them that they did not make the final cut, much the same way we previously sent an email informing them that were previously deemed to be a qualified applicant. In the case where the number of matches was insufficient and the employer's revision to the limits adds candidates, the automated job placement system 120 sends an e-mail to those candidates who were previously rejected and were not qualified, notifying these candidates that they are now qualified. Thus, the employers would be using the automated job placement system 120 not only for pre-qualification but also to narrow the field of qualified applicants.

Summary

The present automated job placement system uses a multi-step process, including advanced screening and pre-qualification of candidates and/or positions, to match prospective employees with job openings. This unique automated job placement system supports two types of participant match processes that involve prospective employers and prospective employees, one matching candidates with potential employers and the other matching jobs with potential employees. Both types of participant match processes use similar proposal creation procedures, using existing proposals and sample proposal components to enable the participant to efficiently create a new job proposal As part of this existing system, this Continuation-In-Part expands the description of the system pertaining to the creation of skills checklists and the creation of minimum levels that are considered necessary by the creator of the checklists for the applicant to be deemed a qualified applicant.

What is claimed as new and desired to be protected by Letters Patent of the United States is:

1. An automated job placement system connected to a communication medium for automatically matching participants who provide respective sets of information and criteria, comprising:
skills checklist storage means for storing a plurality of skills checklists;
skills questions storage means for storing a plurality of questions for use in skills checklists;
job posting means for receiving a set of information over said communication medium from a prospective employer that defines a job posting, including a selected skills checklist which identifies qualifications of prospective ones of employees and independent contractors for this job posting, comprising:
job posting creation means, responsive to an employer accessing a selected skills checklist from said skills checklist storage means, for enabling said employer to import questions into said selected skills checklist from said skills question storage means and said plurality of skills checklists stored in said skills checklist storage means; and
skills checklist editing means for enabling said employer to edit said selected skills checklist and questions included in said selected skills checklist.

2. The automated job placement system of claim 1 further comprising:
skills checklist access means, responsive to said employer selecting an existing skills checklist, for presenting said selected skills checklist to said employer for editing.

3. The automated job placement system of claim 1 wherein said skills checklist storage means comprises:
public skills checklist means for providing said employer with access to a plurality of skills checklists, each of which includes a plurality of questions relating to a defined job description.

4. The automated job placement system of claim 1 wherein said question storage means comprises:
public question means for providing said employer with access to a plurality of questions relating to a defined category of a job description.

5. The automated job placement system of claim 1 further comprising:
question catalog means for indexing said plurality of questions stored in said question storage means by predetermined categories to associate questions of a like nature to enable retrieval of all related questions for review by said employer.

6. The automated job placement system of claim 1 wherein said job posting means further comprises:
prohibited category means for automatically blocking insertion of a question into said selected skills checklist where said question relates to one of a plurality of prohibited categories of information.

7. The automated job placement system of claim 1 wherein said job posting means further comprises:
minimum criteria means, responsive to data input by said employer, for setting minimum levels of skills contained in said selected skills checklist required for the prospective employee to be considered a qualified applicant.

8. The automated job placement system of claim 1 further comprising:
match means for automatically matching prospective ones of employees and independent contractors with a job posting;
indication means for providing said employer with an indication of the number of matches that are determined; and
filter means, responsive to said employer electing to revise said job posting, for reactivating said job posting means to enable said employer to revise said minimum levels of skills contained in said selected skills checklist.

9. The automated job placement system of claim 8 further comprising:
match re-execution means, responsive to said employer revising said job posting, for automatically matching prospective ones of employees and independent contractors with said revised job posting.

10. The automated job placement system for automatically matching participants of claim 9 further comprising:
positive feedback means for automatically notifying said prospective one of an employee and independent contractor when said data input by said prospective one of an employee and independent contractor in response to said list of specific tasks unique to one of said job posting or revised job posting is approved as indicating that said prospective one of an employee and independent contractor is qualified to place offers on said job posting.

11. The automated job placement system for automatically matching participants of claim 9 further comprising:
negative feedback means for automatically notifying said prospective one of an employee and independent contractor when said information received from said prospective one of an employee and independent contractor is declined as indicating that said prospective one of an employee and independent contractor is unqualified to place an employment proposal for one of said job posting and said revised job posting.

12. A method of operating an automated job placement system connected to a communication medium for automatically matching participants who provide respective sets of information and criteria, comprising:
storing a plurality of skills checklists in a skills checklist memory;
storing a plurality of questions for use in skills checklists in a skills questions memory;
receiving a set of information over said communication medium from a prospective employer that defines a job posting, including a selected skills checklist which identifies qualifications of prospective ones of employees and independent contractors for this job posting, comprising:
enabling, in response to an employer accessing a selected skills checklist from said skills checklist memory, said employer to import questions into said selected skills checklist from said skills question memory and said plurality of skills checklists stored in said skills checklist memory; and
enabling said employer to edit said selected skills checklist and questions included in said selected skills checklist.

13. The method of operating an automated job placement system of claim 12 further comprising:
presenting, in response to said employer selecting an existing skills checklist, said selected skills checklist to said employer for editing.

14. The method of operating an automated job placement system of claim 12 wherein said step of storing in said skills checklist memory comprises:
providing said employer with access to a plurality of publicly available skills checklists, each of which includes a plurality of questions relating to a defined job description.

15. The method of operating an automated job placement system of claim 12 wherein said step of storing in said question memory comprises:
providing said employer with access to a plurality of publicly available questions relating to a defined category of a job description.

16. The method of operating an automated job placement system of claim 12 further comprising:
indexing said plurality of questions stored in said question memory by predetermined categories to associate questions of a like nature to enable retrieval of all related questions for review by said employer.

17. The method of operating an automated job placement system of claim 12 wherein said step of receiving further comprises:
automatically blocking insertion of a question into said selected skills checklist where said question relates to one of a plurality of prohibited categories of information.

18. The method of operating an automated job placement system of claim 12 wherein said step of receiving further comprises:
setting, in response to data input by said employer, minimum levels of skills contained in said selected skills checklist required for the prospective employee to be considered a qualified applicant.

19. The method of operating an automated job placement system of claim 12 further comprising:
automatically matching prospective ones of employees and independent contractors with a job posting;
providing said employer with an indication of the number of matches that are determined; and
reactivating, in response to said employer electing to revise said job posting, said step of receiving to enable said employer to revise said minimum levels of skills contained in said selected skills checklist.

20. The method of operating an automated job placement system of claim 19 further comprising:
automatically matching, in response to said employer revising said job posting, prospective ones of employees and independent contractors with said revised job posting.

21. The method of operating an automated job placement system for automatically matching participants of claim 20 further comprising:
automatically notifying said prospective one of an employee and independent contractor when said data input by said prospective one of an employee and independent contractor in response to said list of specific tasks unique to one of said job posting or revised job posting is approved as indicating that said prospective one of an employee and independent contractor is qualified to place offers on said job posting.

22. The method of operating an automated job placement system for automatically matching participants of claim 20 further comprising:
negative feedback means for automatically notifying said prospective one of an employee and independent contractor when said information received from said prospective one of an employee and independent contractor is declined as indicating that said prospective one of an employee and independent contractor is unqualified to place an employment proposal for one of said job posting and said revised job posting.

23. An automated job placement system connected to a communication medium for automatically matching participants who provide respective sets of information and criteria, comprising:
skills checklist storage means for storing a plurality of skills checklists;
skills questions storage means for storing a plurality of questions for use in skills checklists;
job posting means for receiving a set of information over said communication medium from a prospective employee that defines a job posting, including a selected skills checklist which identify qualifications of said employers for this job posting, comprising:
job posting creation means, responsive to an employee accessing a selected skills checklist from said skills checklist storage means, for enabling said employee to import questions into said selected skills checklist from said skills question storage means and said plurality of skills checklists stored in said skills checklist storage means; and
skills checklist editing means for enabling said employee to edit said selected skills checklist and questions included in said selected skills checklist.

24. The automated job placement system of claim 23 further comprising:
skills checklist access means, responsive to said employee selecting an existing skills checklist, for presenting said selected skills checklist to said employee for editing.

25. The automated job placement system of claim 23 wherein said skills checklist storage means comprises:
public skills checklist means for providing said employee with access to a plurality of skills checklists, each of which includes a plurality of questions relating to a defined job description.

26. The automated job placement system of claim 23 wherein said question storage means comprises:
public question means for providing said employee with access to a plurality of questions relating to a defined category of a job description.

27. The automated job placement system of claim 23 further comprising:
question catalog means for indexing said plurality of questions stored in said question storage means by predetermined categories to associate questions of a like nature to enable retrieval of all related questions for review by said employee.

28. The automated job placement system of claim 23 wherein said job posting means further comprises:
prohibited category means for automatically blocking insertion of a question into said selected skills checklist where said question relates to one of a plurality of prohibited categories of information.

29. The automated job placement system of claim 23 wherein said job posting means further comprises:
minimum criteria means, responsive to data input by said employee, for setting minimum levels of skills contained in said selected skills checklist required for the prospective employer to be considered.

30. The automated job placement system of claim 23 further comprising:
match means for automatically matching prospective employers with a job posting;
indication means for providing said employee with an indication of the number of matches that are determined; and
filter means, responsive to said employee electing to revise said job posting, for reactivating said job posting means to enable said employee to revise said minimum levels of skills contained in said selected skills checklist.

31. The automated job placement system of claim 23 further comprising:
match re-execution means, responsive to said employee revising said job posting, for automatically matching prospective employers with said revised job posting.

32. The automated job placement system for automatically matching participants of claim 31 further comprising:
positive feedback means for automatically notifying said prospective employer when said data input by said prospective employer in response to said list of specific tasks unique to one of said job posting or revised job posting is approved as indicating that said prospective employer is qualified to place offers on said job posting.

33. The automated job placement system for automatically matching participants of claim 31 further comprising:
negative feedback means for automatically notifying said prospective employer when said information received from said prospective employer is declined as indicating that said prospective employer is unqualified to place an employment proposal for one of said job posting and said revised job posting.

34. A method of operating an automated job placement system connected to a communication medium for automatically matching participants who provide respective sets of information and criteria, comprising:
storing a plurality of skills checklists in a skills checklist memory;
storing a plurality of questions for use in skills checklists in a skills questions memory;
receiving a set of information over said communication medium from a prospective employee that defines a job posting, including a selected skills checklist which identifies qualifications of prospective ones of employers for this job posting, comprising:
enabling, in response to an employee accessing a selected skills checklist from said skills checklist memory, said employee to import questions into said selected skills checklist from said skills question memory and said plurality of skills checklists stored in said skills checklist memory; and
enabling said employee to edit said selected skills checklist and questions included in said selected skills checklist.

35. The method of operating an automated job placement system of claim 34 further comprising:
presenting, in response to said employee selecting an existing skills checklist, said selected skills checklist to said employee for editing.

36. The method of operating an automated job placement system of claim 34 wherein said step of storing in said skills checklist memory comprises:
providing said employee with access to a plurality of publicly available skills checklists, each of which includes a plurality of questions relating to a defined job description.

37. The method of operating an automated job placement system of claim 34 wherein said step of storing in said question memory comprises:
providing said employee with access to a plurality of publicly available questions relating to a defined category of a job description.

38. The method of operating an automated job placement system of claim 34 further comprising:
indexing said plurality of questions stored in said question memory by predetermined categories to associate questions of a like nature to enable retrieval of all related questions for review by said employee.

39. The method of operating an automated job placement system of claim 34 wherein said step of receiving further comprises:
automatically blocking insertion of a question into said selected skills checklist where said question relates to one of a plurality of prohibited categories of information.

40. The method of operating an automated job placement system of claim 34 wherein said step of receiving further comprises:
setting, in response to data input by said employee, minimum levels of skills contained in said selected skills checklist required for the prospective employer to be considered a qualified applicant.

41. The method of operating an automated job placement system of claim 34 further comprising:
automatically matching prospective employers with a job posting;
providing said employee with an indication of the number of matches that are determined; and
reactivating, in response to said employee electing to revise said job posting, said step of receiving to enable said employee to revise said minimum levels of skills contained in said selected skills checklist.

42. The method of operating an automated job placement system of claim 41 further comprising:
automatically matching, in response to said employee revising said job posting, prospective employers with said revised job posting.

43. The method of operating an automated job placement system for automatically matching participants of claim 42 further comprising:
automatically notifying said prospective employer when said data input by said prospective employer in response to said list of specific tasks unique to one of said job posting or revised job posting is approved as indicating that said prospective employer is qualified to place offers on said job posting.

44. The method of operating an automated job placement system for automatically matching participants of claim 42 further comprising:
negative feedback means for automatically notifying said prospective employer when said information received from said prospective employer is declined as indicating that said prospective employer is unqualified to place an employment proposal for one of said job posting and said revised job posting.

45. An automated job placement system for automatically matching participants who provide respective sets of information and criteria to a computer system that is connected to a communication medium, comprising:
skills checklist storage means for storing a plurality of skills checklists;
skills questions storage means for storing a plurality of questions for use in skills checklists;
posting means for receiving a set of information over said communication medium that defines a posting comprising a proposal and a skills checklist that identify qualifications of prospective participants for this proposal, comprising:
posting creation means, responsive to a listing participant accessing a selected skills checklist from said skills checklist storage means, for enabling said listing participant to import questions into said selected skills checklist from said skills question storage means and said plurality of skills checklists stored in said skills checklist storage means; and
skills checklist editing means for enabling said listing participant to edit said selected skills checklist and questions included in said selected skills checklist.

46. The automated job placement system of claim 45 further comprising:
skills checklist access means, responsive to said listing participant selecting an existing skills checklist, for presenting said selected skills checklist to said participant for editing.

47. The automated job placement system of claim 45 wherein said skills checklist storage means comprises:
public skills checklist means for providing said listing participant with access to a plurality of skills checklists, each of which includes a plurality of questions relating to a defined posting.

48. The automated job placement system of claim 45 wherein said question storage means comprises:
public question means for providing said listing participant with access to a plurality of questions relating to a defined category of a posting.

49. The automated job placement system of claim 45 further comprising:
question catalog means for indexing said plurality of questions by predetermined categories to associate questions of a like nature to enable retrieval of all related questions for review by said listing participant.

50. The automated job placement system of claim 45 further comprising:
prohibited category means for automatically blocking insertion of a question into said selected skills checklist where said question relates to one of a plurality of prohibited categories of information.

51. The automated job placement system of claim 45 wherein said job posting means further comprises:
minimum criteria means, responsive to data input by said listing participant, for setting minimum levels of skills contained in said selected skills checklist required for the prospective participant to be considered a qualified applicant.

52. The automated job placement system of claim 45 further comprising:
match means for automatically matching prospective participants with a job posting;
indication means for providing said listing participant with an indication of the number of matches that are determined; and
filter means, responsive to said listing participant electing to revise said job posting, for reactivating said job posting means to enable said listing participant to revise said minimum levels of skills contained in said selected skills checklist.

53. The automated job placement system of claim 52 further comprising:
match re-execution means, responsive to said listing participant revising said job posting, for automatically matching prospective participants with said revised job posting.

54. The automated job placement system for automatically matching participants of claim 53 further comprising:
positive feedback means for automatically notifying said prospective participant when said data input by said prospective participant in response to said list of specific tasks unique to one of said job posting or revised job posting is approved as indicating that said prospective participant is qualified to place offers on said job posting.

55. The automated job placement system for automatically matching participants of claim 53 further comprising:
negative feedback means for automatically notifying said prospective participant when said information received from said prospective participant is declined as indicating that said prospective participant is unqualified to place an employment proposal for one of said job posting and said revised job posting.

56. A method of operating an automated job placement system for automatically matching participants who provide respective sets of information and criteria to a computer system that is connected to a communication medium, comprising:
storing a plurality of skills checklists in a skills checklist memory;
storing a plurality of questions for use in skills checklists in a skills questions memory;
receiving a set of information over said communication medium that defines a posting comprising a proposal and a skills checklist that identify qualifications of prospective participants for this proposal, comprising:
enabling, in response to a participant accessing a selected skills checklist from said skills checklist memory, said participant to import questions into said selected skills checklist from said skills question memory and said plurality of skills checklists stored in said skills checklist memory, and
enabling said participant to edit said selected skills checklist and questions included in said selected skills checklist.

57. The method of operating an automated job placement system of claim 56 further comprising:
presenting, in response to said participant selecting an existing skills checklist, said selected skills checklist to said participant for editing.

58. The method of operating an automated job placement system of claim 56 wherein said step of storing in said skills checklist memory comprises:
providing said participant with access to a plurality of publicly available skills checklists, each of which includes a plurality of questions relating to a defined posting.

59. The method of operating an automated job placement system of claim 56 wherein said step of storing in said question memory comprises:
providing said participant with access to a plurality of questions relating to a defined category of a posting.

60. The method of operating an automated job placement system of claim 56 further comprising:
indexing said plurality of questions by predetermined categories to associate questions of a like nature to enable retrieval of all related questions for review by said participant.

61. The method of operating an automated job placement system of claim 56 further comprising:
automatically blocking insertion of a question into said selected skills checklist where said question relates to one of a plurality of prohibited categories of information.

62. The method of operating an automated job placement system of claim 56 wherein said step of receiving further comprises:
setting, in response to data input by said listing participant, minimum levels of skills contained in said selected skills checklist required for the prospective participant to be considered a qualified applicant.

63. The method of operating an automated job placement system of claim 56 further comprising:
automatically matching prospective participants with a job posting;
providing said listing participant with an indication of the number of matches that are determined; and
reactivating, in response to said listing participant electing to revise said job posting, said job posting means to enable said listing participant to revise said minimum levels of skills contained in said selected skills checklist.

64. The method of operating an automated job placement system of claim 63 further comprising:
automatically matching, in response to said listing participant revising said job posting, prospective participants with said revised job posting.

65. The method of operating an automated job placement system for automatically matching participants of claim 64 further comprising:
automatically notifying said prospective participant when said data input by said prospective participant in response to said list of specific tasks unique to one of said job posting or revised job posting is approved as indicating that said prospective participant is qualified to place offers on said job posting.

66. The method of operating an automated job placement system for automatically matching participants of claim 53 further comprising:
automatically notifying said prospective participant when said information received from said prospective participant is declined as indicating that said prospective participant is unqualified to place an employment proposal for one of said job posting and said revised job posting.

67. A method of operating an automated job placement system that is connected to a communication medium for automatically matching candidates who provide a set of information and criteria in response to a skills checklist that is posted by a listing party, comprising:
enabling a listing party to edit a selected skills checklist and screening criteria included in said selected skills checklist;
providing said listing party with a first set of candidates that match said screening criteria in said selected skills checklist posted by the listing party,
enabling the listing party to modify the screening criteria; and
providing the listing party with a revised set of candidates that match said modified screening criteria in said selected skills checklist posted by the listing party.

68. A method of operating an automated job placement system that is connected to a communication medium for automatically matching candidates who provide a set of information and criteria in response to a skills checklist that is posted by a listing party, comprising:
editing, by said listing party, a selected skills checklist and screening criteria included in said selected skills checklist;
receiving a set of candidates that match said screening criteria in said selected skills checklist posted by said listing party;
modifying said screening criteria, in response to receipt of said first set of candidates; and
receiving a revised set of candidates that match said modified screening criteria in said selected skills checklist posted by the listing party.
